(19) United States
(12) Patent Application Publication
(10) Pub. No.: US 2003/0225711 A1
(43) Pub. Date: Dec. 4, 2003

(54) Method and apparatus for postal user identification and billing

(76) Inventor: Martin Paping, Vaucresson (FR)

Correspondence Address: PERMAN & GREEN, 425 POST ROAD, FAIRFIELD, CT, 06824, US

(21) Appl. No.: 10/355,914

(22) Filed: Jan. 31, 2003

Related U.S. Application Data
(60) Provisional application No. 60/358,175, filed on Feb. 20, 2002.

(51) Int. Cl. G06F 17/00

(52) U.S. Cl. 705/404

(57) ABSTRACT

A franking module is provided which allows the postal customer to apply unique indicia to an item of mail for authorizing postal transactions. The indicia would not include postage and the franking module would have no capability to store and account for postage. The identification data represented by said indicia would include a customer account number registered at the post office for authorization and billing. The indicia would be read and the postage value would be calculated by a post office processor remote from the franking module. the amount of postage would be debited to the customer's account as the postal item clears the initial processing.

### BACKGROUND OF THE INVENTION

1. Field of the Invention

The present invention relates to postage indicia printed on mail items and more particularly, to use of such postal indicia as a means to bill a postal user.

2. Brief Description of Related Developments

Postage meters have been utilized over a long period to print postage indicia on mail items. The postage indicia indicates that postage has been applied to the mail item and that accounting has been effected in respect of the applied postage. Conventionally the postal meter can be leased or rented from commercial enterprises set up for that purpose. Known postage meters include an electronic circuit for carrying out accounting functions in relation to amounts of postage charges applied to mail items. The electronic circuit receives an input of a desired postage charge to be applied to a mail item, carries out accounting in respect of the required postage charge and then operates a printer of the postage meter to print a postage indicium on the mail item. Generally the postage indicium includes at least the postage charge, the date on which the indicium is printed and an identification of the postage meter.

The printer of a prior art postage meter consisted of a rotatable drum printer in which a die plate carried by the drum printed fixed information and settable print wheels carried by the drum printed variable information.

The fixed information comprises a graphical pattern, a meter identification number and the originating postal region for the mail. The variable information comprises an amount of the postage charge and the date of printing the indicium.

The postage meter is generally constructed in a secure manner by being enclosed in a secure housing. The printer is constructed to work integrally with the meter and also is secure. Accordingly the indicia is printed under conditions of security and attempts to operate the meter and printer in a fraudulent manner are minimized.

However, in order to provide additional security with respect to the postage amounts applied to mail items, it is desirable that the indicia on the mail items include authenticating information whereby the authenticity of the indicia can be verified. By including this authenticating information it is possible, by examination of indicia on mail items, to detect indicia which are not genuine resulting in fraud on the postal authority or other carrier.

Postage meters currently available are provided with a digital printer in place of the drum printer. The digital printer is controlled by the electronic circuit of the postage meter to print in a series of cycles a pattern of dots to form the complete indicium. It will be appreciated that, whereas the indicium printed by the drum printer of earlier postage meters is invariable, apart from the value of postage charge and date, the digital printer of currently available postage meters is capable of printing an indicium containing significantly more variable information. Due to the increased flexibility and capability of digital printers as compared with drum printers it is possible to print additional information in the indicium which can be utilized to authenticate the indicium, or recognize indicia printed in an unauthorized manner.

An example of the use of more complex indicium is shown in U.S. Pat. No. 6,308,165, owned in common with the subject application. The disclosure of this patent is incorporated herein by reference.

Because the purpose of the postal meter is to apply postage to mail indicative of the cost of the postage, there has always existed the threat of fraudulent use which can result in loses to the postal service and the authorized user of the meter. As a result there has been considerable effort exerted relating to the security of the process, centered on the postal meter.

With the increased application of point to point communication and internet communication, each being further complicated by wireless communication, there are increased risks of postal meter abuse. A system of secure communication of postal indicia is described in U.S. Pat. No. 6,173,273, which is commonly owned with this application. The disclosure of the '273 patent is incorporated herein by reference. As the technology has advanced there have been many proposed systems for increasing security and facilitating the use and maintenance of postal meters while maintaining security of the basic postal meter transaction.

A continuing problem in the use of postal meters is the need for updating postal information, such as rate changes and the like. U.S. Pat. No. 6,477,511 is directed to facilitating the updating of postal data in a postal meter through the use of chip cards. It is also necessary to provide means to replenish funding as existing limits become depleted. U.S. Pat. No. 6,381,589 describes a system designed for funding authorization. Under some circumstances the registration of a particular item of mail may be desirable. U.S. Pat. No. 6,435,410 describes a system of document registration. All of these advances are centered at the postal meter and therefore tend to increase the cost and complexity of the postal meter.

There is another trend which opposes the use of large complex centralized postal meters and that is the identification of a rapidly expanding market segment involving small business offices and home offices, generally referred to as the SOHO segment.

Recognizing this trend, the Information-Based Indicia Program (IBIP) is proposed by the United States Postal Service (USPS). IBIP is a distributed trusted system which is expected to support new methods of applying postage, such as PC based methods, in addition to, and eventually in lieu of, the current approach, which typically relies on a postage meter to mechanically print indicia on mailpieces. The IBIP requires printing large, high density, two dimensional (2-D) bar codes on mailpieces. The Postal Service expects the IBIP to provide cost-effective assurance of postage payment for each mailpiece processed.

The USPS has published draft specifications for the IBIP. The INFORMATION BASED INDICIA PROGRAM (IBIP) INDICIUM SPECIFICATION, dated Jun. 13, 1996, defines the proposed requirements for a new indicium that will be applied to mail being processed using the IBIP. The INFORMATION BASED INDICIA PROGRAM POSTAL SECURITY DEVICE SPECIFICATION, dated Jun. 13, 1996, defines the proposed requirements for a Postal Security Device (PSD) that will provide security services to support the creation of a new “information based” postage postmark or indicium that will be applied to mail being processed using the IBIP. The INFORMATION BASED INDICIA PROGRAM HOST SYSTEM SPECIFICATION, dated Oct. 9, 1996, defines the proposed requirements for a host system element of the IBIP. The specifications are collectively referred to herein as the “IBIP Specifications”. The IBIP includes interfacing user (customer), postal and vendor infrastructures which are the system elements of the program.

The user infrastructure, which resides at the user's site, comprises a postage security device (PSD) coupled to a host system. The PSD is a secure processor-based accounting device that dispenses and accounts for postal value stored therein. The host system (Host) may be a personal computer (PC) or a meter-based host processor. It is expected that once the IBIP is launched, the volume of meters will increase significantly when the PC-based meters are introduced. Such volume increase is expected in the small office and home office (SOHO) market. A system which is designed to increase the security of such methods is described in U.S. Pat. No. 6,192,473, commonly owned with this application. The disclosure of the '473 patent is incorporated herein by reference.

Within the SOHO segment the normal process of mail varies in complexity and cost from the standard, buying and applying stamps, to the purchase, lease and maintenance of a franking machine. As the processes incorporate, special rates for priority and overnight mail, and changes to the rates, they become more cumbersome, complex and costly, in labor, postage inventory, and upgraded equipment. The use of stamps requires the retention of a variety of denominations of stamps to accommodate the variety of rates. A convenient alternative is, therefore, desirable.

It is a purpose of this invention to provide a system which is constructed to distribute critical functions, formerly performed as the postal meter, to other systems located at the postal carrier or centralized postal clearing house. It is a purpose of this invention to provide a system for applying a postal user identifier to mail by means of a small hand held device such as a personal data assistant, in the nature of a PALM PILOT and the like. It is a purpose of this invention to accomplish the above goals by eliminating the need for the postal user to apply postage and to use available technology for accounting and payment of postage remote from the postage meter.

### SUMMARY OF THE INVENTION

In the system of this invention a franking module is provided which allows the postal customer to apply a unique identifier to an item of mail. This identifier can take many forms, as long as it provides a secure means for authorizing postal transactions and is readable by a scanner at the post office. The identification data would include item specific data for example type of delivery, i.e. overnight, priority, first class and the like, place of origin, and document and source identification. The identification data would also include a customer account number registered at the post office for recognition and billing. The postage value would be calculated by a post office processor substantially as is currently done, but the amount would be debited to the customers account as the postal item clears the initial processing. The post office processor can be located at post offices or remote locations, similar to ATM machines, gas pumps and other commonly used payment facilities. Accounts may vary from deposit accounts which could be replenished by credit card, or billing accounts for which bills would be sent periodically or credit card accounts.

The information contained on the indicia can be simple or complex, including customer ID, individual sender biometrics, mail item identification for tracking as well as the data needed to calculate the postal charge and bill the customer.

The franking module may form part of a hand held franking machine, Palm Pilot, Handy, or the like. It could also be integrated into a traditional franking machine. In operation the module applies an indicia of identification, particular mailing instructions, item identification and other indicia useful in the postal process. The operation is initiated by secure means such as a password or PIN.

The system consists of a franking module and a scanner/reader at the post office which is designed to receive the indicia applied by the franking module. A processing module remote from the meter and preferably centrally located for example at the Post Office, checks the identification and authorizes the postal transaction. The central processor is also designed to calculate postage for a particular item, and apply the calculated postage value to the account of the identified user. Postage and cancellation may then be applied in one printing step. The centralized computer, data storage, and processor is connected by telephone, hardwire, or wireless means to the onsite mail processor which initially receives the mail item and reads the data on the indicia. The reader may be located at a remote location and connected by telephone. Appropriate account and authentication information is maintained in the central processor to receive the data read from the mail item, verify its authenticity, authorize the transaction, and bill the postal customer. The mail may then be cleared for delivery. The central processor would then apply the postal charge for the mail item to the identified customers account and store the information for monthly billing.

Overall a system according to this invention, will provide a more secure postal system which can be monitored to suppress the use of the mail for terrorism, and other criminal purposes. All accounting is removed from the postal meter greatly simplifying the process at the postal customer interface. This also minimizes the risk of unauthorized use, since no value is applied until the mail is received and authorized at the post office or other location. There need be no replenishment of funding at the postal meter, no current rate data need be stored and updated, and therefore security at the postal terminal (meter) becomes no more complex that that of a credit card, debit card or other portable payment device. In addition, the billing and payment process may be delegated to an outside payment service vendor, such as those used by credit card systems.

### BRIEF DESCRIPTION OF THE DRAWINGS

The foregoing aspects and other features of the present invention are explained in more detail below with reference to the following drawing in which:

FIG. 1 is a block diagram of a franking module according to this invention;

FIG. 2 is a block diagram of a postal system according to this invention;

FIG. 3 is a flow diagram of the method of this invention; and

FIG. 4 is a. block diagram of an alternate embodiment of this invention using indicia which includes biometric data.

### DETAILED DESCRIPTION OF THE PREFERRED EMBODIMENTS

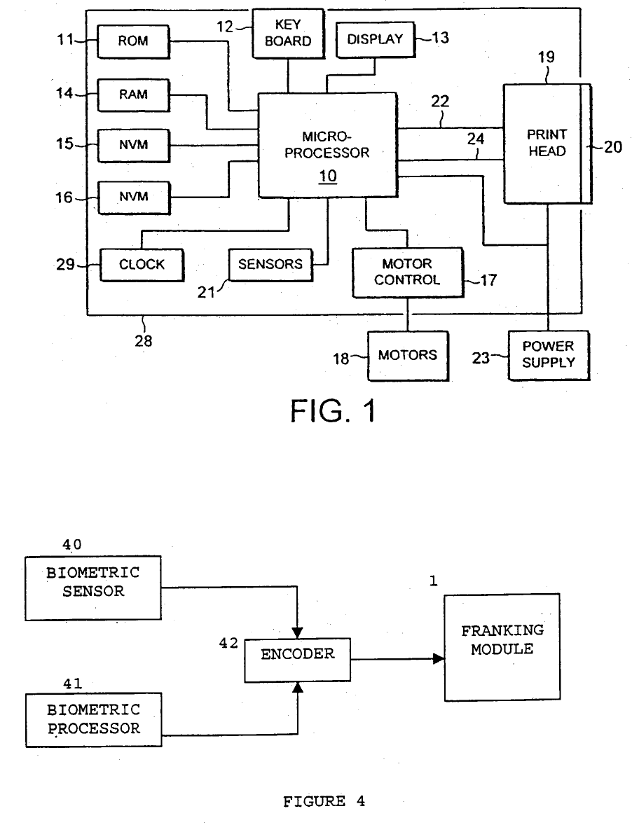

Referring first to FIG. 1 of the drawings, the franking module 1 includes a controller comprising a micro-processor 10 operating under program routines stored in a read only memory (ROM) 11. A keyboard 12 is provided for input of commands and data by a user and a display 13 is provided to enable display of information to the user. A random access memory (RAM) 14 is provided for use as a working store for storage of temporary data during operation of the postage meter. Non-volatile duplicative memories 15, 16 may be provided for the storage of critical data relating to use of the franking module and which is required to be retained even when the postage meter is not powered.

The microprocessor 10 carries out functions in relation to use of the postage meter for franking mail items with postal indicia relating to the authentication and billing for mail items received by the postal authority or other carriers. According to this invention the data incorporated into the indicia will not include postage, but will include a unique identifier code for each postal customer. In addition the indicia data may include item specific information with respect to the postal mode and rate to be used, the point of origin, and an item identifier and other desired information.

Historical data relating to use of the franking module and any other critical data to be retained in the non-volatile memories 15, 16. These data may include an accumulated total count of the number of mail items franked by the module and information relating to the printing of a unique user identifier for authentication. Since no accounting data or postage related data are used by the franking module, the need for memory in the franking module is minimized.

Depending on the size of the module, a motor controller 17 may be connected to the microprocessor 10 to control operation of motors 18, which drive feeding means (not shown) for feeding a mail item past a digital print head 19. The digital print head 19 may be an impact print head in which print elements are selectively energized to impact with an ink ribbon to transfer ink to a mail item or any other form of digital print head and for example may be a non-impact print head. It is preferred to use a non-impact print head such as a thermal print head operating as described hereinafter. The thermal print head includes a plurality of selectively energizable thermal printing elements 20. Sensors 21 are provided to sense and monitor feeding of the mail item. The sensors provide signals to the microprocessor to enable the microprocessor to control feeding of the mail item and to energize selectively the thermal print elements 20 of the print head at appropriate times as the mail item is fed past the print head. As the mail item is fed past the thermal printing elements 20 of the print head 19 during a printing operation, the microprocessor outputs on line 22, in each of a series of printing cycles, print data signals selecting those ones of the printing elements 20 which are to be energized in each respective printing cycle. A pulse of electrical power is supplied to the selected thermal printing elements from a power source 23 when a strobe signal is supplied by the microprocessor on a line 24 to the print head. When printing a bar-code, a plurality of adjacent thermal printing elements are energized in selected printing cycles such as to print narrow and wide bars as required to represent data. The bars may all be of the same length in which case the same number of thermal printing elements are energized in each of the selected printing cycles. However when it is desired to print bars of selected different lengths, the number of thermal printing elements energized in each selected printing cycle is selected to correspond to the required length of bar to be printed.

It will be appreciated, as is well known in the postage meter art, that the franking module 1 must operate in a secure manner and be protected from attempts to use it fraudulently, for example by imprinting the unique user identifier without authorization. Accordingly the franking module is housed in a secure housing 28. Operation of the franking module 1 is controlled by keying in a unique passage word, personal identification number (PIN) or both.

The device according to this invention is preferably constructed as a hand held unit for processing small volumes of mail, perhaps one at a time. Feeding mechanisms will generally not be employed unless the module is installed as part of a more conventional postal meter. The franking module could be controlled by a personal computer, or mini-computer such as a PDA. The control device may be attached to the franking module through the use of smart cards, pcmcia cards and the like.

Each time a franking operation is to be performed by the franking module, the micro-processor carries out a routine in which a determination is made as to whether the operation is authorized. This may be accomplished by using any number of computer security routines, such as those used at ATMs and other computer controlled stations. If proper identification of the user cannot be made the transaction is terminated and the franking indicia is not printed.

The indicia printed on the mail item is in a machine readable form and includes encrypted authentication data. Such data at a minimum will include a user identification which is correlated to an account number and other coded information to protect against unauthorized use. The encrypted authentication data information is printed on the mail item with the item specific information relating to point of origin, mode of postal service, item identification. It is preferred that what ever indicia is used will conform to the IBID host system specification referred to above. The encryption of the data is effected using an algorithm and a secret key so that the encrypted information is not predictable from the data printed in the indicia. The validity of an indicium can be verified by carrying out the same encryption of the printed data and then comparing the resultant encrypted information with the encrypted information printed on the mail item. If the comparison is successful validity of the indicium is verified whereas if the comparison is not successful the indicium is regarded as not authentic. The process for generation of the encrypted information, if desired, may be a reversible encryption process whereby the encrypted information can be decrypted to yield the original data. When a reversible encryption process is used, verification of the indicium may be effected by decrypting the encrypted information printed in the indicium and comparing the decrypted information with the original data. Instead of utilizing encrypted information for verification of the authenticity of the indicium a digital signature may be used.

To facilitate verification of the validity of the indicia it is desirable that the data and encrypted information or digital signature in the indicia is of a form which is machine readable. Accordingly the mail items received at the postal service prior to delivery, can be fed through reading means to scan the indicia on the mail items and computing means coupled to the reading means carries out verification checks on the scanned indicia. Conveniently the postage data and encrypted authentication data are printed in a form suitable for optical character recognition or may be printed in the form of a bar-code. In addition to the machine readable information, the indicium may contain information in human readable form. A method of encryption and authentication which could be used in the system of this invention is described in the above referenced U.S. Pat. No. 6,308,165 and other cited references.

The postal system 2 of this invention, in which the franking module 1 is incorporated, is shown in FIG. 2. Mail items 3 processed in franking module 1 and marked with identification data, as described above, are presented to a scanner or reader 4 at a post office location. The mail item 3 could also be scanned at a remote scanner 5 located at a postal kiosk similar in structure to an ATM. Data, scanned in readers 4 or 5, are sent by cable, fiber optics, wireless communication or similar connection means to a central postal computer server 6. At this point in the process postage has yet to be applied to the mail item. Server 6 has access to customer information data base 7 which contains listings of customer identification data and authentication codes. By comparison of the identification data received from the scanned mail item to the data from the customer information data base 7, authorized use of the franking module 1 can be verified. Once accepted, server 6 initiates the calculation of the postage due and applies it to the customer's account. At this stage, the mail item can be stamped with postage, cleared for further processing, and eventual delivery. It is observed that no postage need be applied, instead, an appropriate clearance or cancellation indicia can be printed on the mail item in a single step.

The postal transaction is duly recorded in the customer information data base 6 or other storage medium. The transaction may then be sent to a centralized billing server at a vendor or postal service location. An appropriate billing process and system is employed for this purpose, such as that described in U.S. Pat. No. 6,233,565, which is hereby incorporated herein by reference.

In a second embodiment, the security capability of the system 2 is enhanced by the use of identification data, which applies to individual users of the franking module. A numerical representation of the biometric characteristics of the user can be incorporated into the indicia printed on the mail item 3 and scanned by the mail carrier or the recipient to verify the identity of the sender.

Biometric information is now being used as an identification and/or verification technique for individuals. As is well known to those having skill in the art, biometric information is one or more behavioral and/or physiological characteristics of an individual. Biometric identification and/or verification uses a data processing system to enable automatic identification and/or verification of identity by computer assessment of a biometric characteristic. In biometric verification, biometric information is verified for a known individual.

In biometric identification, biometric information for an individual is compared to known biometric information for many individuals in order to identify the individual.

Biometric identification/verification systems, methods and computer program products can measure one or more of the following behavioral and/or physiological characteristics of an individual: fingerprint, hand geometry, iris pattern, facial features, voice characteristics, handwriting dynamics, earlobe characteristics and keystroke dynamics. Other biometric characteristics may be used.

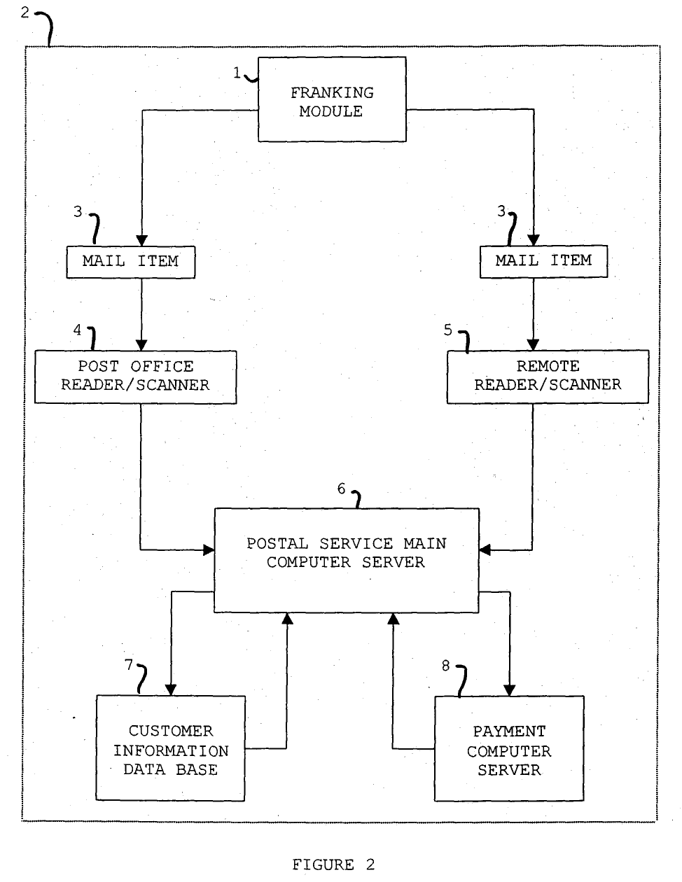

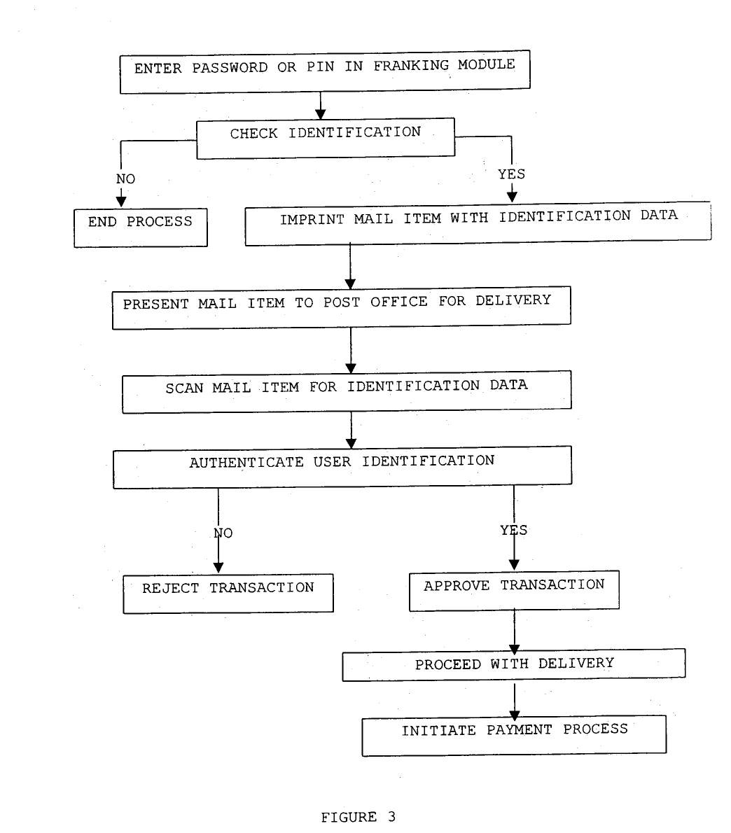

A system for using biometrics can be incorporated into the system 2 of this invention, as shown in FIG. 4. A biometric scanner 40 may be used to record a specific personal characteristics such as a fingerprint. The fingerprint information is digitized in the biometric data processor 41 and coded for printing in encoder 42. The encoded biometric data is printed by the franking module 1. Such a system is described in U.S. Pat. No. 6,507,912, the disclosure of which is incorporated herein by reference.

The operation the system of this invention is shown in FIG. 3. An item of mail 3 is fed into the franking module 1 either directly to the printer 20, or to an appropriate feed mechanism 18. Operation of the franking module 1 is initiated by means of a PIN which is entered by the customer using keypad 12 of the franking module 1. A security algorithm, executable in microprocessor 10, checks the PIN and either authorizes a printing operation or ends the process. Such security algorithms are well known for use with ATM'S and internet transactions. If the microprocessor authenticates the PIN as indicative of an authorized user, the printer is energized to apply identification indica to the mail item 3. The mail item is then transported to a postal scanner and the indicia is read. The data obtained from the scanned indicia is sent to a central computer server where it is authenticated by means of appropriate algorithms. If the indicia is found to be authorized, the transaction is approved.

Once the transaction is approved, the postage is calculated and applied to the mail item if necessary. The mail item postage is cancelled and is transferred to the delivery process in a normal manner. The financial aspect of the postal transaction is transferred to a payment server which could be centralized by postal region or subcontracted to an outside vendor for processing. Since the accounting is accomplished only after the mail is processed, it is not essential that postage actually be applied to the mail item. An appropriate cancellation indicia could be applied immediately after authentication and the mail delivered on that basis. Payment can be obtained in the same manner as bank or credit card transaction.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A system for posting mail by a postal consumer, having apparatus for insuring the authorized payment of postage for a postal transaction comprising:
a franking module constructed to apply identification indicia on a mail item, wherein data contained in said indicia does not include postage, but does include an identifier which is unique to the postal customer, said indicia being machine readable;
a scanner at a location remote from said franking module and accessible by the customer for the presentation of a mail item thereto, said scanner reading said identification indicia on said mail item and transmitting the data read from said indicia to a central processor,
a centralized customer identification database for storing customer data;
wherein said central processor accesses said identification database to compare said read data with said stored data to determine the authenticity of said identification indicia and whether or not use of the indicia was authorized; said central processor generating a signal authorizing or rejecting said postal transaction;
an accounting processor for calculating the amount of postage due on said mail item based on said indicia applied by said franking module, said accounting processor applying said postage due to the account of said postal customer based on said identification indicia; and
a postal printer for applying a marking to the mail item indicative of a completed postal transaction.

2. A system for posting mail by a postal consumer, having apparatus for insuring the authorized payment of postage for a postal transaction, as described in claim 1, further comprising:
a payment server communicating with said accounting processor for recording said postal transaction and billing said customer for the amount of said calculated postage.

3. A system for posting mail by a postal consumer, having apparatus for insuring the authorized payment of postage for a postal transaction, as described in claim 1, wherein said indicia contains data representing a mail item identifier for tracking said mail item.

4. A system for posting mail by a postal consumer, having apparatus for insuring the authorized payment of postage for a postal transaction, as described in claim 1, wherein said indicia contains data relating to the individual user of the franking module.

5. A system for posting mail by a postal consumer, having apparatus for insuring the authorized payment of postage for a postal transaction, as described in claim 1, wherein said franking module includes a microprocessor for executing a security routine to check an identifier entered by the individual user.

6. A system for posting mail by a postal consumer, having apparatus for insuring the authorized payment of postage for a postal transaction, as described in claim 1, wherein said franking module has no capability for storing and accounting for postage.

7. A system for posting mail by a postal consumer, having apparatus for insuring the authorized payment of postage for a postal transaction, as described in claim 4, wherein said data relating to the individual user of the franking module comprises at least one biometric characteristic.

8. A system for posting mail by a postal consumer, having apparatus for insuring the authorized payment of postage for a postal transaction, as described in claim 1, further comprising a sensor for sensing at least one biometric characteristic of said individual user and an encoder for providing coded instructions to enable said biometric characteristic to be printed as part of said indicia.

9. A system for posting mail by a postal consumer, having apparatus for insuring the authorized payment of postage for a postal transaction, as described in claim 1, wherein said franking module comprises a hand held device.

10. A system for posting mail by a postal consumer, having apparatus for insuring the authorized payment of postage for a postal transaction, as described in claim 1, wherein said franking module is controlled by a personal data assistant.

11. A system for posting mail by a postal consumer, having apparatus for insuring the authorized payment of postage for a postal transaction, as described in claim 1, wherein said franking module is controlled by a personal computer.

12. A system for posting mail by a postal consumer, having apparatus for insuring the authorized payment of postage for a postal transaction, as described in claim 1, wherein said franking module is controlled by a traditional postal meter.

13. A system for posting mail by a postal consumer, having apparatus for insuring the authorized payment of postage for a postal transaction, as described in claim 1, wherein said remote location is a mail receiving kiosk.

14. A system for posting mail by a postal consumer, having apparatus for insuring the authorized payment of postage for a postal transaction, as described in claim 1, wherein said remote location is a post office.

15. In a system for posting mail by a postal consumer, having apparatus for insuring the authorized payment of postage for a postal transaction, a method comprising the steps of:
applying identification indicia on a mail item using a franking module, wherein data contained in said indicia does not include postage, but does include an identifier which is unique to the postal customer, said indicia being machine readable;
transferring said mail item to a location remote from said franking module;
scanning said indicia at said remote location and reading said identification indicia on said mail item;
transmitting the data read from said indicia to a central processor,
storing customer data in a centralized customer identification database;
accessing said identification database to compare said read data with said stored data to determine the authenticity of said identification indicia and whether or not use of the indicia was authorized;
generating a signal authorizing or rejecting said postal transaction;
calculating the amount of postage due on said mail item based on said indicia applied by said franking module;
applying said postage due to the account of said postal customer based on said identification indicia; and
applying a marking to the mail item indicative of a completed postal transaction.

16. In a system for posting mail by a postal consumer, having apparatus for insuring the authorized payment of postage for a postal transaction, the method, as described in claim 15, further comprising the step of recording said postal transaction in a payment server and billing said customer for the amount of said calculated postage.

17. In a system for posting mail by a postal consumer, having apparatus for insuring the authorized payment of postage for a postal transaction, the method, as described in claim 15, further comprising the step of providing in said indicia data representing a mail item identifier for tracking said mail item.

18. In a system for posting mail by a postal consumer, having apparatus for insuring the authorized payment of postage for a postal transaction, the method, as described in claim 15, further comprising the step of providing in said indicia data relating to the individual user of the franking module.

19. In a system for posting mail by a postal consumer, having apparatus for insuring the authorized payment of postage for a postal transaction, the method, as described in claim 15, further comprising the step of executing a security routine to check an identifier entered by the individual user.

20. In a system for posting mail by a postal consumer, having apparatus for insuring the authorized payment of postage for a postal transaction, the method, as described in claim 15, wherein there is no capability for storing and accounting for postage.

21. In a system for posting mail by a postal consumer, having apparatus for insuring the authorized payment of postage for a postal transaction, the method, as described in claim 18, wherein said data relating to the individual user of the franking module comprises at least one biometric characteristic.

22. In a system for posting mail by a postal consumer, having apparatus for insuring the authorized payment of postage for a postal transaction, the method, as described in claim 15, further comprising the steps of:
sensing at least one biometric characteristic of said individual user; and
providing coded instructions to enable said biometric characteristic to be printed as part of said indicia.

23. In a system for posting mail by a postal consumer, having apparatus for insuring the authorized payment of postage for a postal transaction, the method, as described in claim 15, further comprising the step of constructing said franking module as a hand held device.

24. In a system for posting mail by a postal consumer, having apparatus for insuring the authorized payment of postage for a postal transaction, the method, as described in claim 15, further comprising the step of controlling said franking module with a personal data assistant.

25. In a system for posting mail by a postal consumer, having apparatus for insuring the authorized payment of postage for a postal transaction, the method, as described in claim 15, further comprising the step of controlling said franking module with a personal computer.

26. In a system for posting mail by a postal consumer, having apparatus for insuring the authorized payment of postage for a postal transaction, the method, as described in claim 15, further comprising the step of controlling said franking module with a traditional postal meter.

27. In a system for posting mail by a postal consumer, having apparatus for insuring the authorized payment of postage for a postal transaction, the method, as described in claim 15, wherein said remote location is a mail receiving kiosk.

28. In a system for posting mail by a postal consumer, having apparatus for insuring the authorized payment of postage for a postal transaction, the method, as described in claim 15, wherein said remote location a post office.
